(19) United States
(12) Patent Application Publication
(10) Pub. No.: US 2021/0220706 A1
(43) Pub. Date: Jul. 22, 2021

(54) GOLF BALL MARKING APPARATUS

(71) Applicant: Jae Ung NAM, Incheon (KR)

(72) Inventor: Jae Ung NAM, Incheon (KR)

(21) Appl. No.: 16/303,664

(22) PCT Filed: Dec. 26, 2017
(86) PCT No.: PCT/KR2017/015446

§ 371 Date: Nov. 21, 2018

(51) Int. Cl. A63B 45/02; B41F 17/30

(52) U.S. Cl. CPC A63B 45/02; A63B 53/0441; B41F 17/30

(57) ABSTRACT

A golf ball marking apparatus for precisely hitting on a dimple formed on a surface of a golf ball, includes: a first frame and a second frame which cover the golf ball to accommodate, and are able to be opened to withdraw the golf ball, wherein the first frame comprises: a reference point marking portion which is provided to be able to mark the surface of the golf ball accommodated in the first frame and the second frame by using a writing instrument; a hit point marking portion which is formed to be spaced apart from the reference point marking portion; and a line marking portion which is formed to penetrate along a virtual straight line connecting the reference point marking portion and the hit point marking portion.

### TECHNICAL FIELD

The present invention relates to a golf ball marking apparatus proposed for marking the surface of a golf ball used in golf sports, and more particularly, to a golf ball marking apparatus capable of visually marking the angle at which the golf ball is placed, the hit position at the time of swing, and the travel direction of the hit golf ball.

### BACKGROUND ART

As the golf population increases day by day, and, as one of the sports for leisure, the popularity of golf is increasing.

The goal of golf is to hit a small ball by using a golf club and put the ball in a hole cup prepared in a specific location.

In this process, the winner is determined depending on the number of hitting the ball, and various factors such as the distance for sending the ball by hitting the ball, the type of the ground on which the ball is placed, the slope, and the like are considered in various ways, and the batting technique suitable for each situation is utilized.

Various types of clubs for hitting a golf ball toward the hole cup include wood, iron, wedge, putter, and the like, and may be selected in consideration of the situation of the ground on which the ball is placed, the distance to the hole cup, and the like.

In addition, in the case of a golf ball hit through the club, a ball having a diameter of about 4.2 cm and a weight of 45.93 g is used.

The surface of the golf ball is provided with a small concave groove for preventing the trajectory of the ball during flight from bending in an unpredictable direction due to the resistance of the air. Such a groove is called a dimple.

Since a small dimple is closely arranged on the surface of the golf ball, there is an irregularity in a position hit by the club.

In this case, when the ball is hit in the normal direction of the center point of the dimple, the irregularity is minimized to improve the accuracy of the hit. However, if the hitting surface of club head and the irregularity due to the dimple of the golf ball are agley in contact with each other, there is a problem in that the golf ball may not be hit in the intended direction and the driving distance is reduced.

Therefore, a method for solving such problems is required.

### DISCLOSURE

### Technical Problem

The present invention has been made to solve the above-mentioned problems of the prior art, and provides a golf ball marking apparatus capable of marking, on the surface of the golf ball, a reference point for placing a golf ball, a hit point that is hit when the golf ball is placed is to direct the reference point in a specific direction, and a line for checking the direction in which the golf ball travels when the ball is hit

The problems of the present invention are not limited to the above-mentioned problems, and other problems not mentioned can be clearly understood by those skilled in the art from the following description.

### Technical Solution

In an aspect, there is provided a golf ball marking apparatus for precisely hitting on a dimple formed on a surface of a golf ball, the golf ball marking apparatus including: a first frame and a second frame which cover the golf ball to accommodate, and are able to be opened to withdraw the golf ball, wherein the first frame includes: a reference point marking portion which is provided to be able to mark the surface of the golf ball accommodated in the first frame and the second frame by using a writing instrument; a hit point marking portion which is formed to be spaced apart from the reference point marking portion and is provided to be able to mark the surface of the golf ball accommodated in the first frame and the second frame by using a writing instrument; and a line marking portion which is formed to penetrate along a virtual straight line connecting the reference point marking portion and the hit point marking portion.

The reference point marking portion is disposed to face upward, the hit point marking portion is disposed in a position where the golf ball is hit during a golf swing, and the reference point marking portion and the hit point marking portion are provided in the same position as the dimple formed on the surface of the golf ball accommodated in the inside of the first frame and the second frame.

### Advantageous Effects

The golf ball marking apparatus of the present invention has a clip shape to easily accommodate a golf ball, and has an advantage of being able to easily mark a reference point, a hit point, and a line that allows to recognize the travel direction on the surface of the golf ball by using a writing instrument in the state where the golf ball is accommodated

In addition, it has an advantage of being able to visually check the placement position of the golf ball when hitting the golf ball, and precisely hitting on the dimple rather than the irregularity at the time of swing so that the golf ball stably can travel in the intended direction while reducing the loss of driving distance.

The effects of the present invention are not limited to the effects mentioned above, and other effects not mentioned can be clearly understood by those skilled in the art from the description of the claims.

### DESCRIPTION OF DRAWINGS

FIG. 1 is a perspective view of a golf ball marking apparatus according to an embodiment of the present invention.

FIG. 2 is a plan view of a golf ball marking apparatus according to an embodiment of the present invention.

FIG. 3 is a front view of a golf ball marking apparatus according to an embodiment of the present invention.

FIG. 4 is a state view showing a state in which a gap between a first frame and a second frame is opened to accommodate a golf ball in a golf ball marking apparatus according to an embodiment of the present invention.

FIG. 5 is a state view showing a state in which a golf ball is accommodated in a golf ball marking apparatus according to an embodiment of the present invention.

FIG. 6 is a state view illustrating a state in which a reference point, a hit point, and a line are marked on a golf ball through a golf ball marking apparatus according to an embodiment of the present invention.

FIG. 7 is a state view illustrating a state in which a golf ball marked through a golf ball marking apparatus according to an embodiment of the present invention is hit.

FIG. 8 is a state view showing a state in which the irregularity of a golf ball is in contact with a club when the golf ball is hit.

FIG. 9 is a state view showing a state in which a club precisely hit on a dimple of a golf ball when the golf ball is hit.

### MODE FOR INVENTION

Hereinafter, preferred embodiments of the present invention will be described with reference to the accompanying drawings. In describing the present embodiment, the same designations and the same reference numerals are used for the same components, and further description thereof will be omitted.

A golf ball marking apparatus according to the present invention may be implemented as follows.

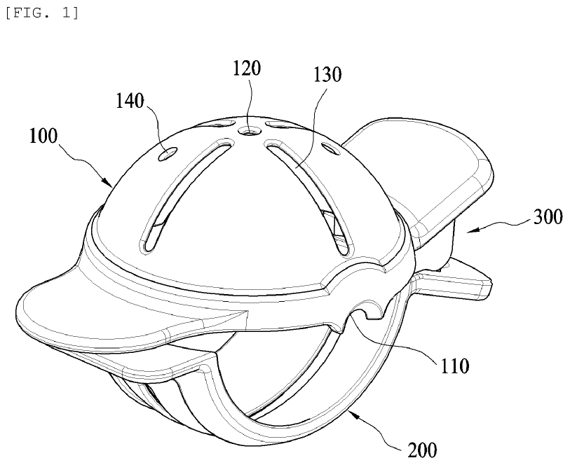

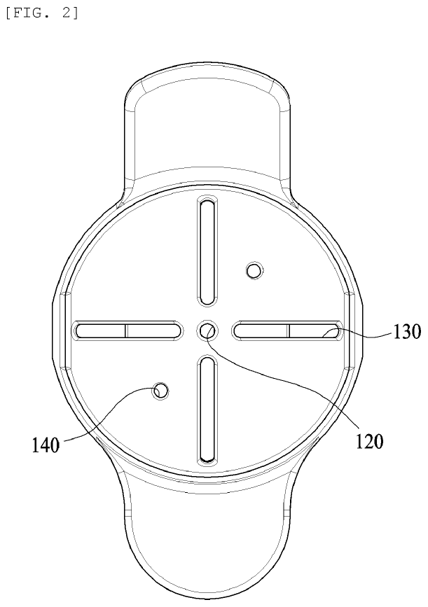

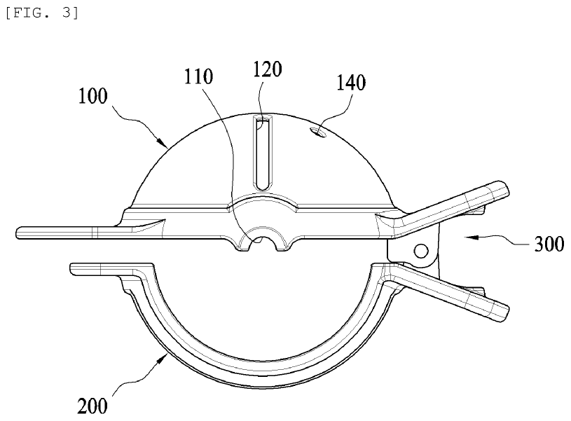

FIG. 1 is a perspective view of a golf ball marking apparatus according to an embodiment of the present invention, FIG. 2 is a plan view of a golf ball marking apparatus according to an embodiment of the present invention, and FIG. 3 is a front view of a golf ball marking apparatus according to an embodiment of the present invention.

Referring to FIG. 1 to FIG. 3, a golf ball marking apparatus according to an embodiment of the present invention is a marking apparatus for precisely hitting on a dimple formed on a surface of a golf ball, and includes a first frame 100 and a second frame 200 which can cover the golf ball to accommodate and can be opened to withdraw the golf ball. The first frame 100 may include a reference point marking portion 120 which is provided to be able to mark a surface of the golf ball accommodated in the first frame 100 and the second frame 200 by using a writing instrument, a hit point marking portion 110 which is formed to be spaced apart from the reference point marking portion 120 and is provided to be able to mark a surface of the golf ball accommodated in the first frame 100 and the second frame 200 by using a writing instrument, and a line marking portion 130 which is formed to penetrate along a virtual straight line connecting the reference point marking portion 120 and the hit point marking portion 110.

Each of the above-described configurations will be described in detail below.

As shown in FIG. 1 to FIG. 3, the golf ball marking apparatus according to an embodiment of the present invention is provided to cover an outer circumference of the golf ball and is suggested to mark the surface of a golf ball with a specific angle or distance.

The first frame 100 may be provided in a hemispherical shape according to an embodiment of the present invention. The size of the hemispherical shape may be determined according to the size of a standard golf ball. The first frame 100 may be provided so as to be in contact with the outer circumference of a circular golf ball.

The first frame 100 having a hemispherical shape may be implemented in various shapes according to an embodiment to which the present invention is applied, and may be provided in a shape corresponding to at least a part of the outer surface of the golf ball so that the golf ball can be seated in an inner space of the first frame 100.

The second frame 200 may be provided to enclose a part of the outer circumference of the golf ball together with the first frame 100, and may be formed such that the golf ball is seated in the inner space formed by the first frame 100 and the second frame 200. One side of the first frame 100 and one side of the second frame 200 may be coupled by a clip 300, and the clip 300 may be provided to couple the first frame 100 and the second frame 200. However, the other sides of the first frame 100 and the second frame 200 may be formed to be opened at a certain interval by an external force.

In one embodiment of the present invention, the clip 300 may be implemented by a coil spring having both ends supported respectively by the first frame 100 and the second frame 200, but the configuration of the clip 300 is not limited to the coil spring. That is, the clip 300 may couple the first frame 100 and the second frame 200 in various forms according to an embodiment of the present invention, and the other sides of the first frame 100 and the second frame 200 may be spaced at an interval enough to allow the golf ball to enter.

The hit point marking portion 110 and the reference point marking portion 120 may be formed in a circular shape or a part of a circular shape so as to be able to draw a virtual circle. Specifically, as shown in FIGS. 1 to 3, the hit point marking portion 110 and the reference point marking portion 120 may be formed in one side of the first frame 100 to have an arc-shaped outer circumference having a certain circumference ratio, or may have a circular shape having a certain circumference ratio to penetrate the first frame 100.

The hit point marking portion 110 and the reference point marking portion 120 may be configured to mark the surface of the golf ball accommodated in the inner space formed by the first frame 100 and the second frame 200 by using a writing instrument, and preferably, may have a shape capable of performing circular marking corresponding to the shape of the dimple as the dimple is formed as a circular concave groove.

In addition, the virtual circle formed by the hit point marking portion 110 and the reference point marking portion 120 may be formed to be equal to or larger than the circle of the dimple of the standard golf ball. The reference point marking portion 120 and the hit point marking portion 110 may be spaced apart from each other with a certain distance therebetween. The mark marked through the reference point marking portion 120, the mark marked through the hit point marking portion 110, and the mark marked through the line marking portion 130 are referred to as the reference point marking portion 120, the hit point marking portion 110, and the line marking portion 130 in an embodiment of the present invention.

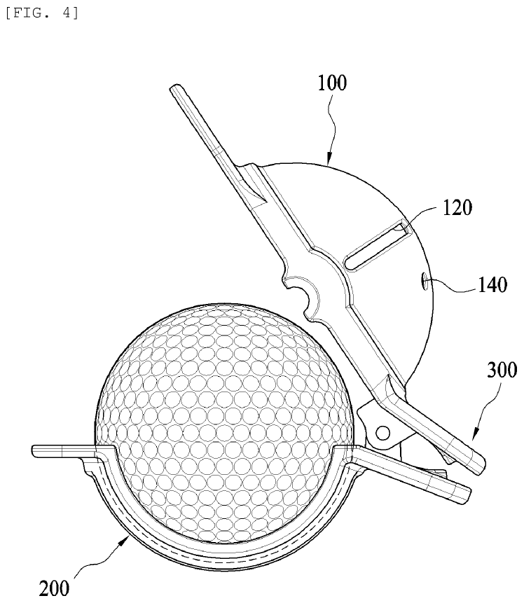

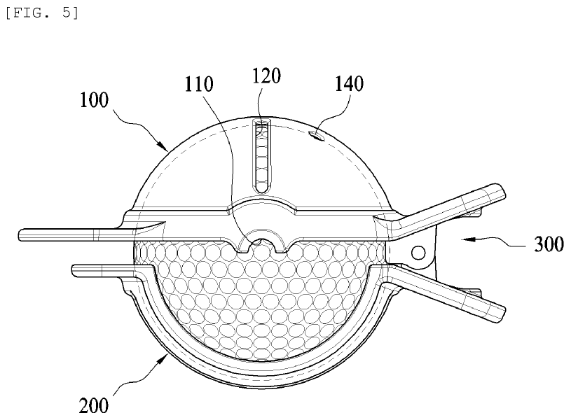

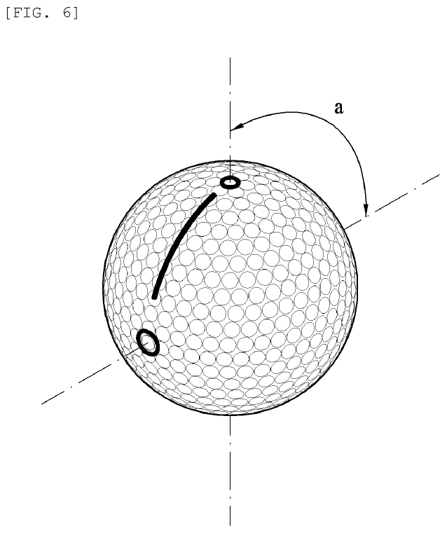

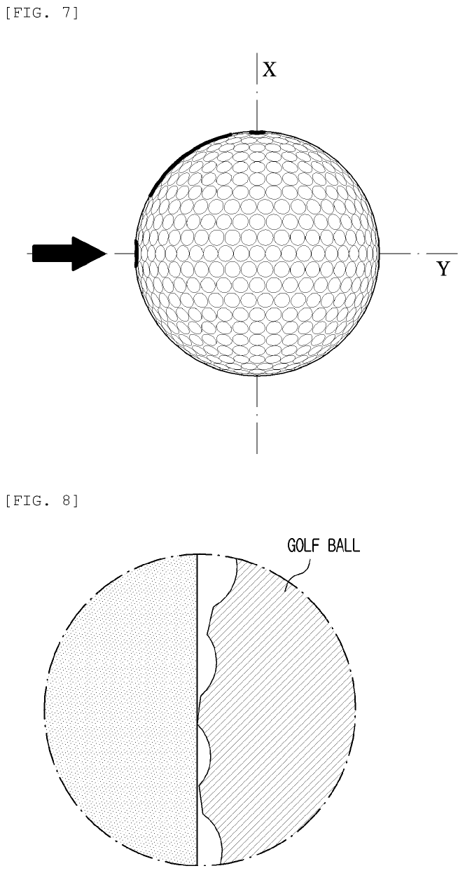

FIG. 4 is a state view showing a state in which a gap between a first frame and a second frame is opened to accommodate a golf ball in a golf ball marking apparatus according to an embodiment of the present invention, FIG. 5 is a state view showing a state in which a golf ball is accommodated in a golf ball marking apparatus according to an embodiment of the present invention, FIG. 6 is a state view illustrating a state in which a reference point, a hit point, and a line are marked on a golf ball through a golf ball marking apparatus according to an embodiment of the present invention, and FIG. 7 is a state view illustrating a state in which a golf ball marked through a golf ball marking apparatus according to an embodiment of the present invention is hit.

As shown in FIG. 6 and FIG. 7, as for each position of the reference point marking portion 120 and the hit point marking portion 110, when the golf ball is positioned such that the reference point marking portion 120 is directed vertically upward, the position of the hit point marking portion 110 may be provided at a position where the golf ball is hit through the club.

As an example, the golf ball is disposed so that the reference point marking portion 120 is directed vertically upward. As shown in FIG. 6 and FIG. 7, the reference point marking portion 120 and the reference point marking portion 120 may be disposed to form an angle of a, which may be calculated in consideration of the type of club used in golf and the golf ball hit position according to the swing.

In addition, the position of the reference point marking portion 120 and the hit point marking portion 110 is determined so as to correspond exactly to the dimple of the golf ball. In this case, when the golf ball is placed such that the reference point marking portion 120 is directed vertically upward, there is an effect that the normal direction of the center point of the dimple in the dimple at the position corresponding to the hit point marking portion 110 coincides with the direction in which the club is hit.

In addition, at least one line marking portion 130 may be provided along a virtual straight line connecting the reference point marking portion 120 and the hit point marking portion 110.

The line marking portion 130 is a long slot formed to be able to mark a specific straight line on the surface of the golf ball. In one embodiment of the present invention, the marked thickness may be formed to be equal to the diameter of the marking marked through the reference point marking portion 120 and the hit point marking portion 110.

The longitudinal direction of the straight line marked on the surface of the golf ball through the line marking unit 130 may coincide with the predicted moving direction of the golf ball when the golf ball is hit. This allows a player who swings during the golf swing to visually provide the direction of the golf ball.

In addition, the first frame 100 may further include a viewpoint marking portion 140.

Separately from the reference point marking portion 120 and the hit point marking portion 110, at least one viewpoint marking portion 140 may be provided in the first frame 100, and two or more viewpoint marking portions 140 may be provided to be selected according to the direction of the player who performs golf swing.

When the reference point marking portion 120 is disposed to be directed vertically upward, the viewpoint marking portion 140 may be disposed at a point where a line of sight of the player is positioned at a position of a player swinging by holding the club.

Therefore, by using the marking marked through the reference point marking portion 120, the hit point marking portion 110, and the viewpoint marking portion 140 and the line marked through the line marking portion 130, the golf player can perform the golf swing as follows.

When the player performs swing while looking at the viewpoint marking unit 140, after performing marking on the surface of the golf ball by using the golf ball marking apparatus according to an embodiment of the present invention through the reference point marking portion 120, the hit point marking portion 110, the viewpoint marking portion 140, and the line marking portion 130, and disposing the reference point marking portion 120 of the marked golf ball to be directed vertically upwardly, the dimple located in the hit point marking portion 110 can be precisely hit so that the golf ball moves along the longitudinal direction of the line marking portion 130.

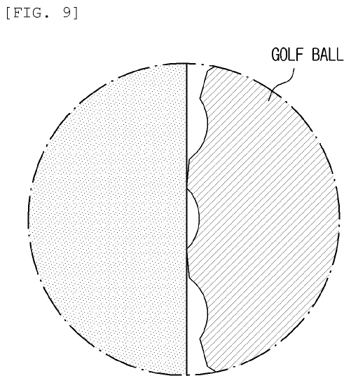

FIG. 8 is a state view showing a state in which the irregularity of a golf ball is in contact with a club when the golf ball is hit, and FIG. 9 is a state view showing a state in which a club precisely hit on a dimple of a golf ball when the golf ball is hit.

As shown in FIG. 8, the golf ball marked by the golf ball marking apparatus according to an embodiment of the present invention makes it possible to reduce a probability that the convex portion of the irregularities of the surface of the golf ball is hit by the club, and to precisely hit the dimple of the golf ball as shown in FIG. 9 when the golfer swings in a correct posture.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A golf ball marking apparatus for precisely hitting on a dimple formed on a surface of a golf ball, the golf ball marking apparatus comprising:
a first frame and a second frame which cover the golf ball to accommodate, and are able to be opened to withdraw the golf ball,
wherein the first frame comprises:
a reference point marking portion which is provided to be able to mark the surface of the golf ball accommodated in the first frame and the second frame by using a writing instrument;
a hit point marking portion which is formed to be spaced apart from the reference point marking portion and is provided to be able to mark the surface of the golf ball accommodated in the first frame and the second frame by using a writing instrument; and
a line marking portion which is formed to penetrate along a virtual straight line connecting the reference point marking portion and the hit point marking portion.

2. The golf ball marking apparatus of claim 1, wherein, when the reference point marking portion is disposed to face upward, the hit point marking portion is disposed in a position where the golf ball is hit during a golf swing, and the reference point marking portion and the hit point marking portion are provided in the same position as the dimple formed on the surface of the golf ball accommodated in the inside of the first frame and the second frame.
